(19) United States
(12) Patent Application Publication
(10) Pub. No.: US 2023/0064992 A1
(43) Pub. Date: Mar. 2, 2023

(54) AUTONOMOUS, DAYTIME-WATERING PLANT IRRIGATION SYSTEM

(71) Applicant: Reynaldo S. Rodriguez Martinez, Newport News, VA (US)

(72) Inventor: Reynaldo S. Rodriguez Martinez, Newport News, VA (US)

(21) Appl. No.: 17/409,924

(22) Filed: Aug. 24, 2021

(51) Int. Cl. A01G 27/00

(52) U.S. Cl. CPC A01G 27/003; A01G 27/008; A01G 27/005

(57) ABSTRACT

A plant irrigation system for autonomous outdoor daytime-watering includes a rigid endothermic container having first and second ports in fluid communication with the container's interior volume. With the container on the ground, the first port is above the second port relative to the ground. An indicator coupled to the container identifies a fill level such that, when the container is on the ground, less than 50% of the container's interior volume lies below the fill level. A lid provides sealing engagement with the first port. An open-ended conduit has a first end and a second end. The first end is sealingly coupled to the second port, and the second end is adapted to be positioned near a plant. The conduit is configured to traverse a path such that a portion of the path is above the container's identified fill level when the container is on the ground.

### FIELD OF THE INVENTION

The invention relates generally to plant irrigation, and more particularly to a plant irrigation system that autonomously waters an outdoor plant during warmer daytime hours.

### BACKGROUND OF THE INVENTION

Outdoor plantings around one's home or business contribute to attractive and welcoming appearances as well as adding to a property's value. While beautiful, most in-ground or potted native and ornamental plants are expensive as is the cost to properly plant and maintain them. To protect this type of investment, property owners know that plants need to be watered. Such watering can be accomplished manually or with irrigation systems. However, manual watering is time consuming, is often neglected or forgotten, and frequently results in under watering or over watering conditions. Conventional irrigation systems are expensive to install. Furthermore, conventional irrigation systems use moving sprinkler parts (e.g., sprinkler heads), underground pipes and couplings, and timing and/or moisture-sensing control systems that require frequent maintenance leading to ongoing maintenance down-time and the expenses associated therewith.

### SUMMARY OF THE INVENTION

Accordingly, it is an object of the present invention to provide an irrigation system for outdoor plants.

Another object of the present invention is to provide an outdoor plant irrigation system that waters plants autonomously.

Still another object of the present invention is to provide an outdoor plant irrigation system that is reliable, economical, and uses ambient environmental conditions to control irrigation output.

Other objects and advantages of the present invention will become more obvious hereinafter in the specification and drawings.

In accordance with the present invention, a plant irrigation system for autonomous daytime-watering includes a rigid endothermic container adapted to be positioned on a ground surface in an outdoor environment. The container has a first port and a second port in fluid communication with the container's interior volume. When the container is on the ground surface, a first height of the first port above the ground surface is greater than a second height of the second port above the ground surface. An indicator is coupled to the container for identifying a fill level of the container such that, when the container is on the ground surface, less than 50% of the container's interior volume lies below the fill level. A lid provides sealing engagement with the first port. An open-ended conduit has a first end and a second end. The first end is sealingly coupled to the second port, and the second end is adapted to be positioned near a plant. The conduit is configured to traverse a path such that a portion of the path is above the container's identified fill level when the container is on the ground surface.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic part sectional and part side view of a plant irrigation system supporting a potted plant thereon and illustrated in its daytime watering mode of operation in accordance with an embodiment of the present invention;

FIG. 2 is a schematic part sectional and part side view of the plant irrigation system illustrated in FIG. 1 in its nighttime watering mode of operation;

FIG. 3 schematic part sectional and part side view of a plant irrigation system that includes an overflow port/valve in accordance with another embodiment of the present invention;

FIG. 4 is a schematic part sectional and part side view of a plant irrigation system for use in a planting bed in accordance with an embodiment of the present invention;

FIG. 5 is a schematic part sectional and part side view of a plant irrigation system incorporating an open recessed volume to contain a plant in accordance with another embodiment of the present invention; and

FIG. 6 is a schematic part sectional and part side view of the plant irrigation system illustrated in FIG. 5 further incorporating drainage for the open recessed volume in accordance with yet another embodiment of the present invention.

### DETAILED DESCRIPTION OF THE INVENTION

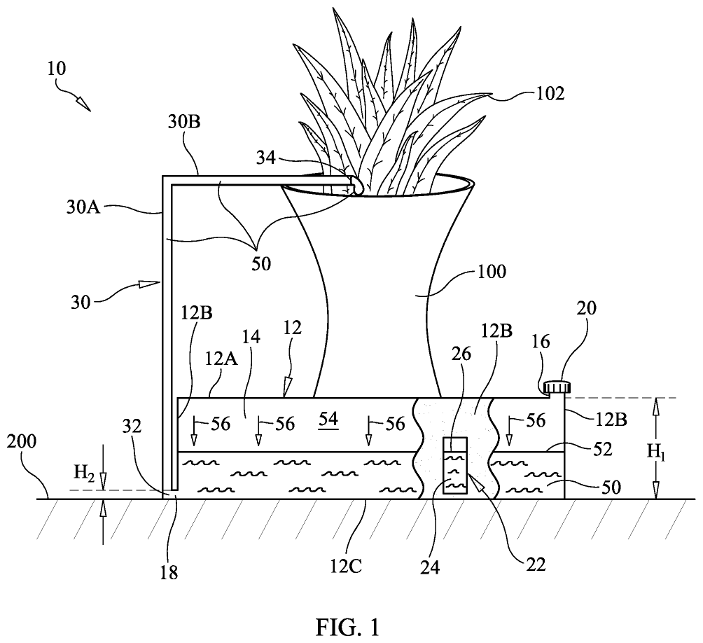

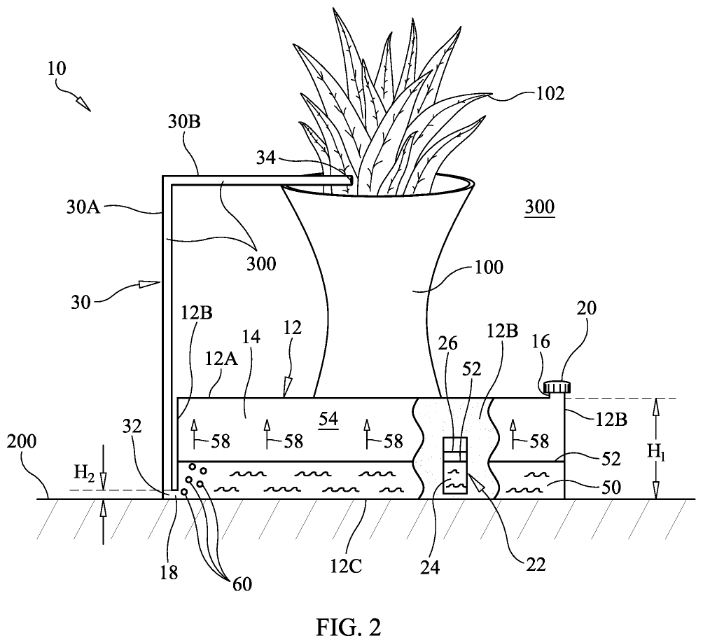

Referring now the drawings, simultaneous reference will be made to FIGS. 1 and 2 where a plant irrigation system is illustrated in a schematic part sectional and part side view thereof and is referenced generally by numeral 10. In the illustrated embodiment, plant irrigation system 10 supports a pot 100 thereon with a plant 102 in pot 100. The type/shape of pot 100 and type of plant 102 are not limitations of the present invention. As will be explained further below, plant irrigation system 10 provides small amounts of an irrigating liquid 50 to plant 102 during daytime hours (FIG. 1), and does not supply any irrigating liquid 50 to plant 102 during nighttime hours (FIG. 2). Irrigating liquid 50 can be water or water mixed with one or more plant nutrients without departing from the scope of the present invention.

Plant irrigation system 10 includes a rigid container 12 configured for placement on a ground surface 200 (e.g., plant bed, patio, walkway, deck, stairs, etc.). Container 12 includes a base 12A, side walls 12B, and a top 12C such that container 12 defines an interior volume 14 for holding liquid 50 therein. Container 12 can be constructed as one piece (e.g., molded) or could be an assembled structure without departing from the scope of the present invention. For reasons that will be explained later herein, container 12 must remain rigid at all times. If needed for container rigidity, internal supports (not shown) can be provided inside container 12. Container 12 can be realized by a variety of sizes and shapes without departing from the scope of the present invention. For example, in the illustrated embodiment, base 12A and top 12C can be parallel to one another when container 12 will be placed on a relatively level ground surface 200 such that pot 100 can be placed on top 12A. However, the present invention is not so limited as the container could also be configured as a decorative garden feature that may or may not support a potted plant thereon.

Regardless of its size or shape, container 12 is constructed to be endothermic, i.e., one that absorbs heat from its surrounding environment. At a minimum, side walls 12B and top 12C are configured to be heat absorbing or endothermic for ready passive absorption of available outdoor environmental heat during daytime hours. For example, at least side walls 12B and top 12C can be painted in a dark color (e.g., black, dark navy, dark green, etc.) or made from such dark colored materials. Base 12A can also be configured to be endothermic and can be a significant source of heat absorption when ground surface 200 is one that heats up when in sunlight (e.g., pavement, bricks, deck materials, etc.).

In the illustrated embodiment, container 12 has a liquid fill port 16 in top 12A, and has an egress/recharge port 18 in a side wall 12B immediately adjacent to base 12A. It is to be understood that fill port 16 can also be placed in a side wall 12B as will be explained later herein. However, in all embodiments of the present invention with container 12 on ground surface 200, the height “H₁” of port 16 above ground surface 200 is greater than the height “H₂” of port 18 above ground surface 200. Removably coupled to port 16 is a sealing lid 20 that forms an airtight and water tight seal with port 16. Lid 20 can be of any design that is removable from port 16 to permit introduction of liquid 50, and that seals port 16 when in place.

For purposes of plant irrigation in accordance with the present invention, the amount of liquid 50 in container 12 must always be less than 50% of the total volume defined by interior volume 14. The remainder of the total volume of interior volume 14 is air 54 above the top surface 52 of liquid 50. To enable adherence to this requirement, an indicator 22 is provided on container 12. Since container 12 will generally have liquid 50 added thereto when base 12A rests on ground surface 200, indicator 22 identifies a maximum fill level for liquid 50 when container 12 is resting on ground surface 200. That is, when container 12 is on ground surface 200, indicator 22 identifies a location in container 12 where less than 50% of interior volume lies between base 12A and indicator 22. For many applications, indicator 22 identifies the location in container 12 where 30-49% of interior volume 14 lies between indicator 22 and base 12A when container 12 is on ground surface 200. For example, for a container whose interior volume was 10,000 cubic centimeters, indicator 22 could identify a less-than-50% fill volume ranging from 3 to 4.9 liters. Lower volume percentages can be used when a container is to be positioned or configured for use on sloped ground surfaces.

Indicator 22 can be realized in one or more ways without departing from the scope of the present invention. For example and as shown in the illustrated example, indicator 22 can be a visual indicator constructed as a transparent or translucent window 24 in side wall 12B with a visible marking 26 on window 24 to indicate the maximum level for top surface 52 of liquid 50. Window 24 can extend towards base 12A to provide a user with knowledge about how much liquid 50 remains in container 12. In some embodiments of the present invention, indicator 22 could be supplemented or replaced with an audible indicator (e.g., a liquid sensor coupled to a sound producer) and/or a tactile indicator (e.g., a flexible diaphragm that is pushed out from side wall 12B when liquid 50 presses there against).

Plant irrigation system 10 also includes an open-ended conduit (e.g., tube, hose, etc.) 30 having a first open end 32 coupled to egress/recharge port 18 and having a second open end 34 for positioning in ambient air near the base of plant 102. Conduit 30 traverses a path from open end 32 to open end 34 such that a portion of the path is above the fill level of container 12 identified by marking 26 in the illustrated example. To assure this condition, some or all of conduit 30 can be rigid. For example, all of conduit 30 could be made from plastic tubing. In other embodiments, the vertical portion 30A of conduit 30 could be rigid and the horizontal portion 30B could be flexible to provide for adjustability in the positioning of open end 34. However, in all embodiments of the present invention, the inside diameter of conduit 30 to include that of open ends 32 and 34 is approximately 0.25 inches or less.

In operation with container 12 on ground surface 200, lid 20 is removed from port 16 and liquid 50 is introduced into container 12 to a level not to exceed that indicated by marking 26. Lid 20 is then replaced on port 16 to form a seal therewith. The combination of liquid 50, container 12, and lid 20 define a sealed volume for air 54. During typically warmer daytime hours as illustrated in FIG. 1, endothermic container 12 absorbs heat from the ambient environment surrounding container 12 such that air 54 inside of container 12 is heated and expands. The rigidity of container 12 assures that the heat-generated expansion of air 54 causes pressure to be applied to top surface 52 of liquid 50 as indicated by arrows 56. As the daytime heating process progresses and pressure 56 is continuously applied to liquid 50, some of liquid 50 is forced out through port 18 and into/through conduit 30 until it exits open end 34 just above the base of plant 102. Pressure 56 on liquid 50 continues throughout the warm portion of a day to supply a steady and low volume of irrigation to plant 102. The small (i.e., 0.25 inches or less) inside diameter of conduit 30 allows relatively small amounts of heat-generated pressure 56 (caused by expanding air volume 54) to generate a flow of liquid 50 into and through conduit 30 even when open end 34 is above the container's fill level identified by, for example, marking 26.

As daytime heating transitions to nighttime cooling (FIG. 2), the volume of air 54 in container 12 contracts with such cooling being indicated by arrows 58. When this occurs, top surface 52 of liquid 50 is allowed to move up in container 12 thereby creating a vacuum at port 18 to draw liquid 50 from conduit 30 back into container 12. As nighttime cooling contraction 58 continues, ambient air 300 is sucked into conduit 30 at open end 34. The ambient air 300 is ultimately drawn through port 18 and into liquid 50 where it bubbles up as indicated at 60 until it ultimately is mixed with air 54 in container 12. Thus, over the course of nighttime cooling, plant irrigation system 10 is recharged with ambient air above top surface 52 of liquid 50 thereby readying plant irrigation system 10 for the next daytime heating/watering cycle.

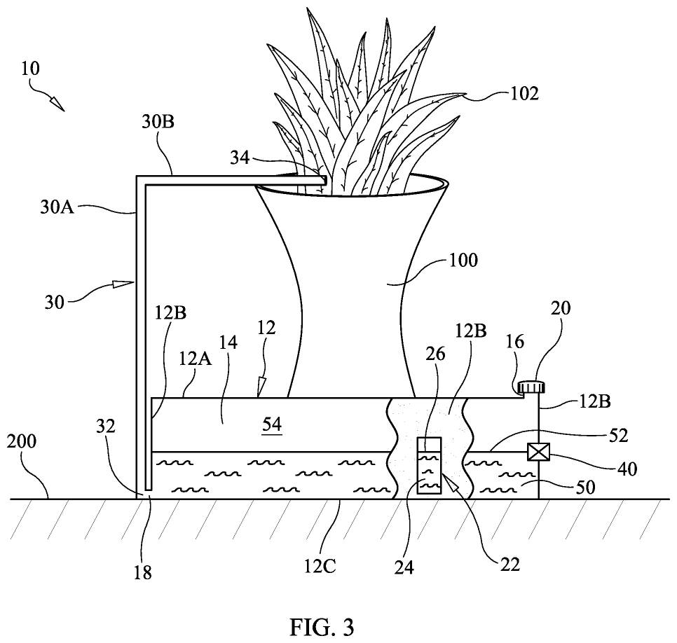

In other embodiments of the present invention, an overflow drain can be incorporated into the system's container. For example and as illustrated in FIG. 3, an overflow port 40 can be provided in side wall 12B of container 12. Port 40 can be a controllable or automated valve positioned coincident with the fill level provided by indicator 22 (e.g., marking 26). When container 22 is to be replenished with liquid 50, port/valve 40 is manually or automatically opened such that top surface 52 of liquid 50 never exceeds the prescribed level for the plant irrigation system. In some embodiments of the present invention, the above-described port 16/lid 20 could be positioned at the location of port/valve 40 to provide a combination of the filling, sealing, and overflow protection functions for the plant irrigation system.

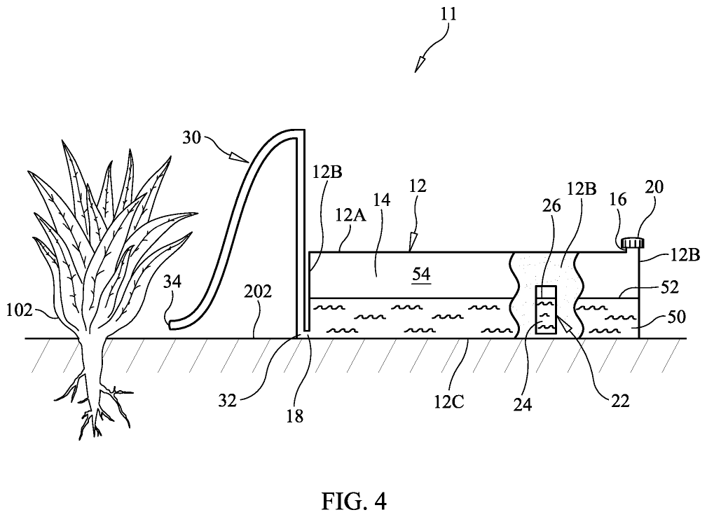

In some embodiments of the present invention, the plant irrigation system can be used to irrigate bedding plants as shown in FIG. 4 where a plant irrigation system 11 rests on the surface 202 of a planting bed. Plant irrigation system 11 is similar to the previously-described system 10 except that conduit 30 is configured or shaped to position its open end 34 just above surface 202. While open end 34 is below the fill level of container 12 defined by marking 26, a portion of the path traversed by conduit 30 is configured to be above the less-than-50% fill level when container 12 is on surface 202 in accordance with the present invention.

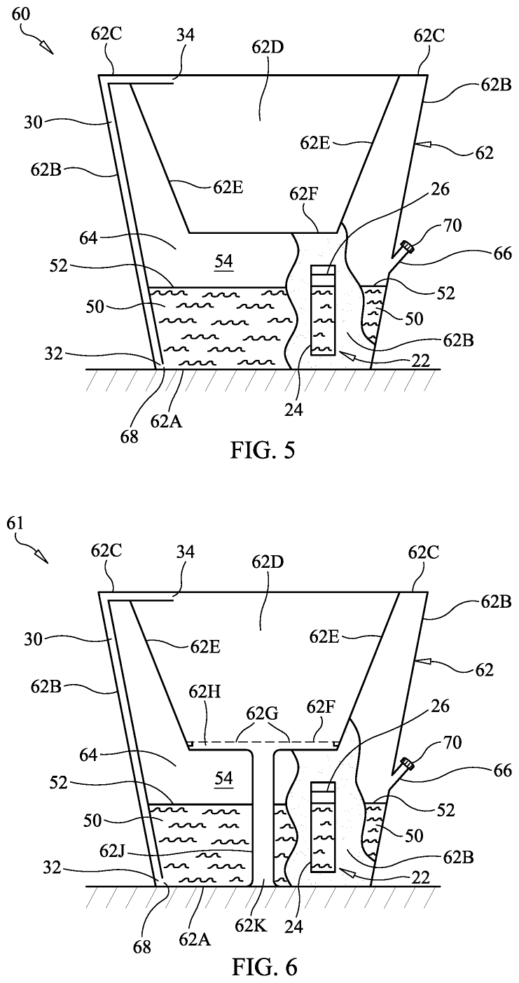

In still other embodiments of the present invention, the plant irrigation system's container can incorporate an open recessed volume that serves as a flower or plant pot/container. For example and as illustrated in FIG. 5, a plant irrigation system 60 has a rigid endothermic container 62 (e.g., painted black or some other dark color and/or made from black/dark color materials) with an interior volume 64. Container 62 has a base 62A, outer side walls 62B, and a top 62C. In addition, container 62 defines an open recessed volume 62D within an annular upper region of container 62. Open recessed volume 62D is formed by inner side walls 62E and an inner base 62F, and serves as a pot/container for holding soil and a plant (not shown). Conduit 30, which can be integrated with outer side wall 62B, traverses a path from its open end 32 coupled to a port 68 immediately adjacent to base 62A to its open end 34 at the top of open recessed volume 62D. Another port 66 is positioned in outer side wall 62B to be coincident with the fill level (e.g., marking 26) of indicator 22 as described previously herein. A removable lid 70 seals port 66 thereby providing a combination of the filling, sealing, and overflow protection functions of the plant irrigation system.

FIG. 6 illustrates another plant irrigation system 61 that is similar to the above-described plant irrigation system 60, but also includes a plant drainage feature. More specifically, inner base 62F has perforations 62G to allow liquid to pass there through. A basin 62H positioned below inner base 62F collects excess liquid for drainage through a line 62J having an outlet 62K at base 62A. In this way, excess irrigation liquid provided to recessed volume 62D is returned to the surrounding (outdoor) environment.

The advantages of the present invention are numerous. Outdoor plants are autonomously irrigated using naturally-occurring temperature swings between daytime and nighttime hours. Temperature differences of 10° F. or greater are very common between daytime hours and nighttime hours. The present invention takes advantage of the day/night temperature difference as well as sunlight heating effects to irrigate during day and recharge with ambient air during the night. No control system or daily monitoring of the system is required. Requirements for replenishment of irrigating liquid are dependent on the size of the plant irrigation system and local temperature day/night ranges.

Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A plant irrigation system for autonomous daytime-watering, comprising:
a rigid endothermic container adapted to be positioned on a ground surface in an outdoor environment, said container having an interior volume, said container having a first port and a second port in fluid communication with said interior volume wherein, when said container is on the ground surface, a first height of said first port above the ground surface is greater than a second height of said second port above the ground surface;
an indicator coupled to said container for identifying a fill level of said container wherein, when said container is on the ground surface, less than 50% of said interior volume lies below said fill level;
a lid for sealing engagement with said first port; and
an open-ended conduit having a first end and a second end, said first end sealingly coupled to said second port, said second end adapted to be positioned near a plant, said conduit configured to traverse a path wherein a portion of said path is above said fill level when said container is on the ground surface.

2. A plant irrigation system as in claim 1, wherein said first port is coincident with said fill level when said container is on the ground surface.

3. A plant irrigation system as in claim 1, further comprising a sealable port in said container coincident with said fill level.

4. A plant irrigation system as in claim 1, wherein said conduit is configured to have said second end thereof positioned above said fill level when said container is on the ground surface, and wherein said conduit has an inside diameter not to exceed approximately 0.25 inches.

5. A plant irrigation system as in claim 1, wherein said conduit comprises a rigid material for at least a portion thereof.

6. A plant irrigation system as in claim 1, wherein said container is configured to have an open recessed volume above said fill level when said container is on the ground surface.

7. A plant irrigation system as in claim 6, further comprising a drain having an inlet in fluid communication with said open recessed volume, said drain having an outlet adapted to be in fluid communication with the outdoor environment.

8. A plant irrigation system as in claim 1, wherein said container has a base for engagement with the ground surface, and wherein said second port is immediately adjacent to said base.

9. A plant irrigation system as in claim 1, wherein said indicator comprises a visual indicator.

10. A plant irrigation system for autonomous daytime-watering, comprising:
a rigid endothermic container having a base, walls coupled to said base, and a top coupled to said walls, said container adapted to be positioned on a ground surface in an outdoor environment with said base engaging the ground surface, said container having an interior volume, said container having a first port in one of said walls and said top, said first port being in fluid communication with said interior volume, said container having a second port in one of said walls immediately adjacent to said base wherein, when said container is on the ground surface, a first height of said first port above the ground surface is greater than a second height of said second port above the ground surface;
a single indicator coupled to said container for identifying a fill level of said container wherein, when said container is on the ground surface, 30-49% of said interior volume lies between said fill level and said base;
a liquid in said container wherein said liquid occupies less than 50% of said interior volume, said liquid including water;
a lid for sealing engagement with said first port; and
an open-ended conduit having a first end and a second end, said conduit having an inside diameter not to exceed approximately 0.25 inches, said first end sealingly coupled to said second port, said second end adapted to be positioned in ambient air near a plant, said conduit configured to traverse a path wherein a portion of said path is above said fill level when said container is on the ground surface.

11. A plant irrigation system as in claim 10, wherein said first port is coincident with said fill level when said container is on the ground surface.

12. A plant irrigation system as in claim 10, further comprising a sealable port in said container coincident with said fill level.

13. A plant irrigation system as in claim 10, wherein said conduit is configured to have said second end thereof positioned above said fill level when said container is on the ground surface.

14. A plant irrigation system as in claim 10, wherein said conduit comprises a rigid material for at least a portion thereof.

15. A plant irrigation system as in claim 10, wherein said container is configured to have an open recessed volume above said fill level when said container is on the ground surface.

16. A plant irrigation system as in claim 15, further comprising a drain having an inlet in fluid communication with said open recessed volume, said drain having an outlet adapted to be in fluid communication with the outdoor environment.

17. A plant irrigation system as in claim 10, wherein said walls and said top of said container are black in color.

18. A plant irrigation system as in claim 10, wherein said indicator comprises a visual indicator.

19. A plant irrigation system for autonomous daytime-watering, comprising:
a rigid endothermic container having a base adapted to rest on a ground surface in an outdoor environment, said container having an interior volume, said container having a first port in fluid communication with said interior volume above said base when said container is on the ground surface, said container having a second port in fluid communication with said interior volume immediately adjacent to said base wherein, when said container is on the ground surface, a first height of said first port above said base is greater than a second height of said second port above said base;
a visual indicator coupled to said container for identifying a fill level of said container wherein, when said container is on the ground surface, less than 50% of said interior volume lies below said fill level;
a lid for sealing engagement with said first port; and
an open-ended conduit having a first end and a second end, said conduit having an inside diameter not to exceed approximately 0.25 inches, said first end sealingly coupled to said second port, said second end adapted to be positioned near a plant, said conduit configured to traverse a path wherein a portion of said path is above said fill level when said container is on the ground surface.

20. A plant irrigation system as in claim 19, wherein said first port is coincident with said fill level when said container is on the ground surface, and wherein said conduit comprises a rigid material for at least a portion thereof for positioning said second end of said conduit above said fill level when said container is on the ground surface.

21. A plant irrigation system as in claim 19, wherein said container is configured to have an open recessed volume above said fill level when said container is on the ground surface, and further comprising a drain having an inlet in fluid communication with said open recessed volume, said drain having an outlet adapted to be in fluid communication with the outdoor environment.
